(19) United States
(12) Patent Application Publication
(10) Pub. No.: US 2019/0377187 A1
(43) Pub. Date: Dec. 12, 2019

(54) OPTICAL SYSTEM FOR NEAR-EYE DISPLAYS

(71) Applicant: LUMUS LTD., Ness Ziona (IL)

(72) Inventors: Yuval RUBIN, Tel Aviv (IL); Elad SHARLIN, Mishmar David (IL)

(21) Appl. No.: 16/476,009

(22) PCT Filed: Jan. 3, 2018
(86) PCT No.: PCT/IL2018/050010

§ 371 Date: Jul. 3, 2019

Related U.S. Application Data
(60) Provisional application No. 62/442,070, filed on Jan. 4, 2017.

(51) Int. Cl. G02B 27/01; G02B 27/00; G02B 3/00

(52) U.S. Cl. CPC G02B 27/0172; G02B 27/0081; G02B 2027/0118; G02B 2027/0123; G02B 3/0056

(57) ABSTRACT

An optical system and method are presented for use in a near-eye display device for projecting a virtual image. The optical system comprises: an optical unit defining a light guiding channel for guiding input light indicative of the virtual image through said channel and providing output light with a field of view, said output light having a predetermined non-uniform intensity profile across said field of view; and a masking optical element optically coupled to an output of said optical unit for output light passage through the masking optical element, said masking optical element having a spatially varying transmission profile across said element configured in accordance with said predetermined non-uniform intensity profile, to affect regions of relatively high light intensity within said intensity profile to thereby apply intensity modulation to light passing through the masking optical element to provide virtual image with improved light intensity uniformity.

### TECHNOLOGICAL FIELD

The present invention is generally in the field of virtual imaging, and relates to an optical system for use in a near-eye displays for displaying virtual images. More specifically, the invention relates to an optical system for near-eye displays based on a lightguide coupler.

### BACKGROUND

The main physical principle of the operation of a lightguide coupler used in near-eye displays (NEDs) is that light waves, indicative of a virtual image, are trapped inside a substrate by total internal reflections from the major surfaces of the substrate, and are coupled out into the eyes of the viewer by one or more internal reflecting or partially reflecting/diffractive surfaces. One of the important factors defining the performance of the NED is associated with a requirement for uniformity of illumination formed by light output from the lightguide coupler. The non-uniformities, or irregularities, are intrinsic to the lightguide based NEDs, regardless of the physics of the coupling-out. The irregularities can look like fringes, or bands of lower/higher intensity over the image, with angular frequencies lay roughly in a range between ¼ of the field of view (FOV) and FOV/100. In light-guide architectures that address colors independently, these appear as color variations across the scene.

### GENERAL DESCRIPTION

As described above, one of the important factors defining the performance of the NED in a virtual imaging system is a requirement for uniformity of illumination/brightness across the field of view of the system output. for example, in PCT patent publication number WO2016/132347, assigned to the same assignee of the present invention, a non-uniformity in the resulting image might occur due to the different reflection sequences of different rays that reach each selectively reflecting surface: some rays arrive without previous interaction with a selectively reflecting surface; other rays arrive after one or more partial reflections. PCT patent publication number WO2016/132347 provides beam splitting coating averaging up the brightness of the dark and light areas of the image. Furthermore, to avoid dark as well as bright stripes in the image, an exact plate thickness should be chosen.

The present invention provides a novel optical system and a method thereof to correct brightness irregularities in virtual-image light. This is implanted in the invention by using specifically designed masking optical element optically coupled to an optical unit guiding virtual-image light. In some embodiments, the optical system is configured for at least partially obstructing regions of different brightness in the image, and/or redistributing the non-uniform brightness to give uniform result.

The invention can be used in a see-through NED. The invention can be implemented to advantage in a large number of imaging applications, such as, for example, head-mounted and head-up displays, cellular phones, compact displays, 3-D displays, compact beam expanders as well as non-imaging applications such as flat-panel indicators, compact illuminators and scanners.

According to one broad aspect of the invention, it provides an optical system for use in a near-eye display device for projecting a virtual image. The optical system comprises:

an optical unit defining a light guiding channel for guiding input light indicative of the virtual image through said channel and providing output light with a field of view, said output light having a predetermined non-uniform intensity profile across said field of view; and

a masking optical element optically coupled to an output of said optical unit for output light passage through the masking optical element, said masking optical element having a spatially varying transmission profile across said element configured in accordance with said predetermined non-uniform intensity profile, to affect regions of relatively high light intensity within said intensity profile to thereby apply intensity modulation to light passing through the masking optical element to provide virtual image with improved light intensity uniformity.

In some embodiments, the spatially varying transmission profile of the masking optical element is configured to affect the light intensity in the regions of relatively high light intensity to be below a certain threshold.

The masking optical element may comprise a pattern formed by an array of two or more spaced-apart regions of different transmissions, thereby providing the spatially varying transmission profile. Alternatively, or additionally, the spatially varying transmission profile of the masking element is achieved by providing in the masking optical element a pattern of successive regions of continuously varying transmission.

The pattern of the masking element is characterized by a predetermined arrangement of the regions of different transmissions (spaced-apart or successively adjacent) is defined by such pattern parameters as predetermined dimensions of the regions and/or spaces between them and/or optical density of said regions.

In some embodiments, the pattern of the masking element providing the spatially varying transmission profile corresponds to a projection of the predetermined non-uniform intensity profile across the field of view at the output of the optical unit onto the masking optical element.

In some embodiments, the optical unit comprises a light guiding element configured to guide the input light propagation therethrough via total internal reflections from major surfaces of the light guiding element. For example, the light guiding element may be configured as a beam expander. The light guiding element may comprise a substrate/body having the major surfaces and one or more at least partially reflective surfaces embedded in the substrate for reflecting the light indicative of the virtual image out of the body towards the masking optical element.

In some embodiments, the optical system also comprises an additional (second) optical unit optically coupled to the masking optical element for guiding the intensity modulated light emerging from the masking optical element to be output from the display device in one or more output directions. Such second optical unit may be configured as a light-guide for guiding light propagation therethrough by total internal reflection from major surface of the light guide, and having one or more at least partially reflective surfaces for reflecting the virtual image light towards one or more output directions. The second optical unit may be configured as a beam expander.

In some embodiments, the first and second optical units are configured as first and second beam expanders to successively expand the light indicative of the virtual image along two perpendicular axes, respectively. For example, at least the light guide of the second optical unit is configured as a see-through light guide element for guiding the virtual image being projected and transmitting a real scene image, thereby augmenting the virtual image onto the real scene image.

According to another broad aspect of the invention, there is provided an optical system for use in a near-eye display device for projecting a virtual image, the system comprising:

first and second light guiding elements, each configured for guiding input light indicative of the virtual image through a substrate of the light guiding element by total internal reflections from major surfaces of the substrate, the first and second light guiding elements being accommodated in a cascaded fashion such that the second guiding element is optically coupled to an output of the first guiding element; and

a masking optical element accommodated at an optical interface between the first and second light guiding elements for optically coupling the light outputted from the first guiding element with a certain field of view to an input of the second light guiding element, wherein said masking optical element has a spatially varying transmission profile across said element configured in accordance with a predetermined non-uniform intensity profile of the light output of the first light guiding element across said field of view, said spatially varying transmission profile affecting regions of relatively high light intensity within said non-uniform intensity profile, thereby applying intensity modulation to the light passing through the masking optical element to improve intensity uniformity of light being input to the second light guiding element.

According to yet further broad aspect of the invention, there is provided an optical system for use in a near-eye display device for projecting a virtual image, the system comprising:

an optical unit having an optical pupil, and configured to define a light guiding channel for guiding light through said channel to be output from the optical unit in one or more output directions; and

a masking optical element accommodated upstream of the optical unit with respect to a general propagation direction of light through the optical system, said masking optical element projecting input light indicative of the virtual image onto said optical pupil of the optical unit, wherein said masking optical element has a spatially varying transmission profile across said element configured in accordance with a predetermined non-uniform intensity profile of the input light, to affect regions of relatively high light intensity within said non-uniform intensity profile, thereby applying intensity modulation to the light passing through the masking optical element to improve intensity uniformity of light being input to the optical pupil of the optical unit.

The optical unit may comprise a light guiding element configured to guide the light propagation therethrough via total internal reflections from major surfaces of the light guiding element. The light guiding element might be configured as beam expander.

The invention in its yet further aspect provides a method for improving intensity uniformity of light, indicative of a virtual image in a near-eye display device. The method comprises:

providing data indicative of a non-uniform intensity profile of input light indicative of the virtual image across a certain field of view; and

analyzing said data indicative of the non-uniform intensity profile of the input light, and determining a spatially varying transmission profile to be applied to the input light across said certain field of view to apply intensity modulation to the input light to affect regions of relatively high light intensity within said intensity profile and thereby improve intensity uniformity of said light.

As indicated above, the spatially varying transmission profile may be configured to affect the light intensity in the relatively high light intensity regions to be below a certain threshold. The spatially varying transmission profile may comprise a pattern formed by an array of two or more spaced-apart regions of different transmissions, and/or a pattern of successive regions of continuously varying transmission. The spatially varying transmission profile may be determined by at least one of dimensions, pitch and optical density of the pattern regions.

The data indicative of the non-uniform intensity profile may be provided by conducting preliminary measurements of optical characteristics of the optical unit producing said input light indicative of the virtual image, and identifying an arrangement of the regions of relatively high light intensity in the field of view.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A shows a schematic illustration of an optical system to be used in a near-eye display projecting a virtual scene;

FIGS. 1B and 1C show schematically two specific, non-limiting examples of the optical system for use in (see through) near-eye displays, utilizing the principles of the invention by appropriately placing specifically designed masking optical element in between optical units of the system;

FIG. 2 shows an image of an input scene with and without using the masking optical element of the present invention;

FIGS. 3A-3C show examples of different positions of the masking optical element in the optical system of a near-eye display;

FIG. 3D more specifically illustrates an example of a light guiding expander suitable to be used in the optical systems of FIGS. 3A-3C; and

FIG. 4 shows different possible varying transmission profiles of the masking optical element according to some embodiments of the present invention.

### DETAILED DESCRIPTION OF EMBODIMENTS

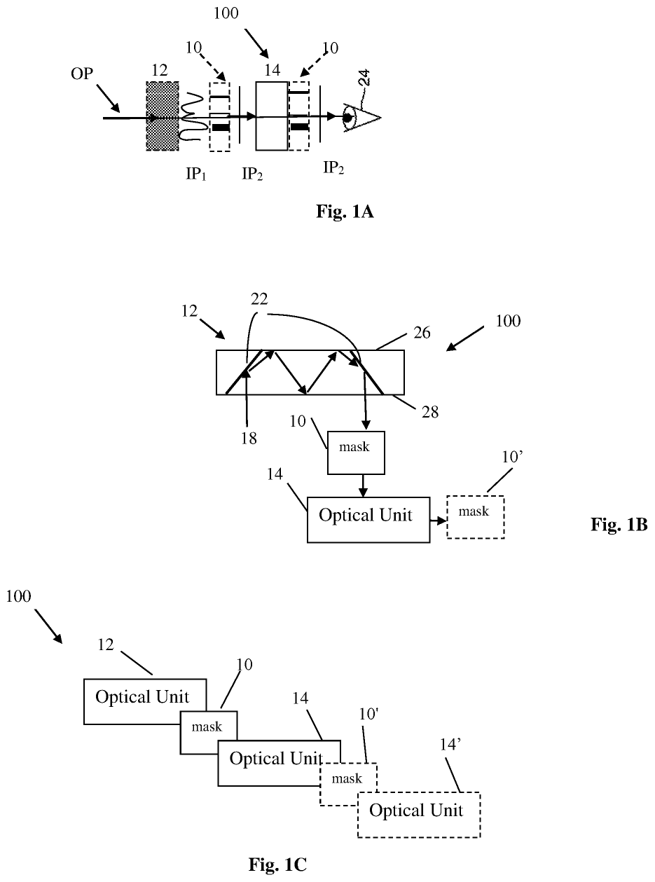

FIG. 1A illustrates one non-limiting example of embodiments of the present invention. The present invention provides a novel optical system 100 to be used in a near-eye display device for projecting a virtual image. Optical system 100 comprises an optical unit 12 defining a light guiding channel for guiding input light indicative of the virtual image through the channel and providing output light with a field of view. As shown, the output light typically has a certain non-uniform intensity profile IP₁ across the field of view. Further provided in the optical system 100 is a masking optical element 10 optically coupled to an output of optical unit 12 and allowing output light passage through the masking optical element.

Masking optical element 10 has a spatially varying transmission profile across the element configured in accordance with the predetermined non-uniform intensity profile IP₁ of the optical unit 12 upstream thereof. Such non-uniform intensity profile IP₁ has regions of relatively high and relatively low illumination intensities. The spatially varying transmission profile of the element 10 is configured to affect regions of the relatively high light intensity within said intensity profile to thereby apply intensity modulation to light passing through masking optical element 12 to improve intensity uniformity of light emerging from masking optical element 12.

Optical unit 12 has a certain transfer function defining the non-uniform light intensity profile IP₁. Optical unit 12 is not limited to any configuration and may be any at least partially transparent optical unit receiving and transmitting light indicative of a virtual image. For example, optical unit 12 may be an optical coupler and/or combiner and/or a beam expander, and/or a light-guide optical element (e.g. LOE). The LOE is a waveguide/substrate guiding light by total internal reflection from the major surfaces thereof and including a plurality of at least partially reflecting surfaces for directing light out of the waveguide towards one or more output directions. The masking optical element 10 defines a transmission pattern formed by an array of two or more regions of different transmissions, thereby providing the spatially varying transmission profile and transferring light of the virtual image with a substantially uniform intensity profile IP₂ across the field of view of the display.

In some embodiments, as will be exemplified further below, optical system 100 comprises an additional optical unit 14 optically coupled to masking optical element 10 for guiding the intensity modulated light emerging from the masking optical element 10 to be output in one or more output directions. The additional optical unit 14 is configured for projecting the image towards an eye 24 and defining a common light optical path OP with the optical unit 12 and with the masking optical element 10.

Generally, masking element 10 is placed in an intermediate plane between the input and output planes defined by the optical path OP through the optical system 100. Considering the example of two optical units 12 and 14, the masking element 10 may be located therebetween downstream to the first optical element along the optical path OP and adjacent (or in a near proximity) to the input of the second optical element.

The display may be implemented for augmented or virtual reality applications. If the display is configured for augmented reality, i.e. configured as a see-through near-eye display device, the second optical unit 14 is configured for projecting an augmented image (formed by a real scene and virtual images) towards the eye 24. In this case, masking element 10 is positioned at an intermediate plane, i.e. upstream/before the second optical unit 14. If the display is configured for virtual reality (near-eye display device), the second optical unit 14 is configured for projecting a virtual image towards the eye 24. In this case, masking element 10 may be positioned also at a plane after the second (last) optical unit 14. The spatially varying transmission profile then corresponds to the transfer functions of the optical unit 14.

Thus, generally, the masking optical element 10 is located at the output of an optical unit whose illumination uniformity across the field of view is to be improved, and such masking optical element has a pattern of spatially variable transmission configured in accordance with illumination non-uniformity of said optical unit.

Masking element 10 may be located close to, up to a physical contact with, the output surface of the optical unit 12 or at a certain distance thereof. The masking element 10 can be fabricated as a patterned element/film using any known patterning technique, As indicated such as: lithography patterning including thin-film-based partial absorbers/reflectors and/or binary micro-structures, (e.g. polka-dot, wire grid, random patterns, including varying density), absorption filters, including semi-transparent layers, thin-films, photographic film, printing, precise printing of binary structures on a transparent substrate, any technique used for writing and/or replication of diffractive structures, including ruling, etching, printing, holographic methods.

Thus, generally, the masking optical element 10 has a pattern formed by an array of two or more regions (e.g. spaced-apart regions) of different transmissions (e.g. at least partially obstructing regions), thereby providing the spatially varying transmission profile. The varying transmission profile is determined in accordance with illumination no-uniformity of the optical unit upstream of the masking element to control the brightness of the light and to thereby transfer (direct) light of the virtual image with a substantially uniform intensity profile IP₂. Such spatially varying transmission of the masking optical element 10 may be implemented by a pattern of successive regions of continuously varying transmission.

In some embodiments, the regions of different transmissions correspond to a projection of the predetermined non-uniform intensity profile IP₁ across the field of view onto the masking optical element 10 such that the regions having an intensity above a certain threshold are at least partially obstructed. For example, the threshold level may be defined as the level of brightness of the background of the image. The regions of relatively high light intensity as compared to the background brightness are at least partially masked in order to level the brightness with respect to the adjacent regions.

It should be understood that the optical system 100 exemplified here presents a single-eye part of the near-eye display. The two-eye system, although not specifically shown here, is formed by similar, identically symmetric (mirror symmetry) systems 100.

In general, the masking element 10 can have an arbitrary spectral response.

Also, it should be noted that because of the positioning of the masking element 10, the optical system is not limited to any angular span and therefore it covers a large angular span. As described above, it can be fabricated from cheap elements and with non-costly processes (no vacuum technique, heat etc. needed). Also, the thickness of the masking element 10 is non-critical and can be varied as desired.

FIGS. 1B and 1C illustrate specific examples of the present invention. To facilitate understanding the same reference numbers are used to identify functionally common components in all the examples of the invention. In the example of FIG. 1B, the optical system 100 includes two optical units 12 and 14 with a masking element 10 in between. Thus, in this example, element 10 is configured in accordance with the intensity non-uniformity profile (predetermined and/or modeled) induced by the light propagation through the preceding optical unit 12.

As shown, optionally, the system 100 includes an additional masking element 10′ at the output of the optical unit 14. In this case, the element 10′ is configured in accordance with an intensity non-uniformity profile further induced by optical unit 14. It should be noted, although not specifically shown, that optical unit which creates intensity non-uniformity may be formed by one or more separate optical elements such as light guides, lenses, etc. In the specific example of FIG. 1B, the optical unit 12 is a substrate-guided optical module or lightguiding optical element (LOE) configured for guiding input light 18 indicative of virtual image from an image generator or input collimator as the case may be (which are not specifically shown) by total internal reflection from major surfaces 26, 28 of the LOE which has light directing (at least partially reflective) surfaces/interfaces 22 directing light out of the LOE in one or more output directions. The masking element 10 is located at the output of the LOE 12. As indicated above, the masking element may be a stand-alone unit at the output of the LOE 12.

It should, however, be noted that the masking element 10 might be implemented by patterning a respective output facet of the LOE 12 or attaching a patterned film thereto. Hence, in this case, in order to keep the total internal reflection condition for light propagation through the system, the masking element is configured for operation in a reflection mode, i.e. the spatially varying transmission profile of the mask applies the illumination uniformity improving optical coding to light incident thereon and reflects the light rather than allowing its propagation through the mask in the original incident direction. Hence, such masking element creates a reflected light field of the improved illumination uniformity, and this light is properly directed by a respective light directing surface embedded in the LOE towards an output direction.

As shown, the optical system 100 may comprise a second optical unit 14 downstream of the masking element 10, as well as may comprise further masking element 10′. The second optical unit 14 may or may not be LOE-like unit. Considering the near-eye virtual image display, the masking element may be located at the output of the system (e.g. in addition to a masking element at the intermediate location along the entire path through the system), while in case of see-through configuration of the near-eye display, there is no such masking element at the output of the entire system.

All the elements/parts of the optical system might be integrated in a common housing, forming a closed arrangement, while not necessarily being in physical contact between them. Since the substrate-guided optical element is very compact and lightweight, it could be installed in a vast variety of arrangements. This embodiment is designated for applications where the display should be near-to-eye: head-mounted, head-worn or head-carried.

It should also be noted that the masking element 10 is configured such that the total internal reflection of the light inside the LOE's substrate 12 as well as the coupling of the light in and out the substrate 12 are not affected. In particular, both s and p polarization, at all angles, are treated.

FIG. 1C exemplifies an optical system 100 having a cascaded arrangement of multiple assemblies each formed by an optical unit whose illumination non-uniformity is to be corrected and the correcting masking element. More specifically, masking element 10 is configured to correct illumination non-uniformity of optical unit 12 upstream thereof; the so-corrected light field enters a successive, second optical unit 14, and in case such optical unit also induces illumination non-uniformity, it is followed by a correspondingly-designed masking element 10′, which might be followed by a further optical unit 14′, which in this example is the output element of optical system 100.

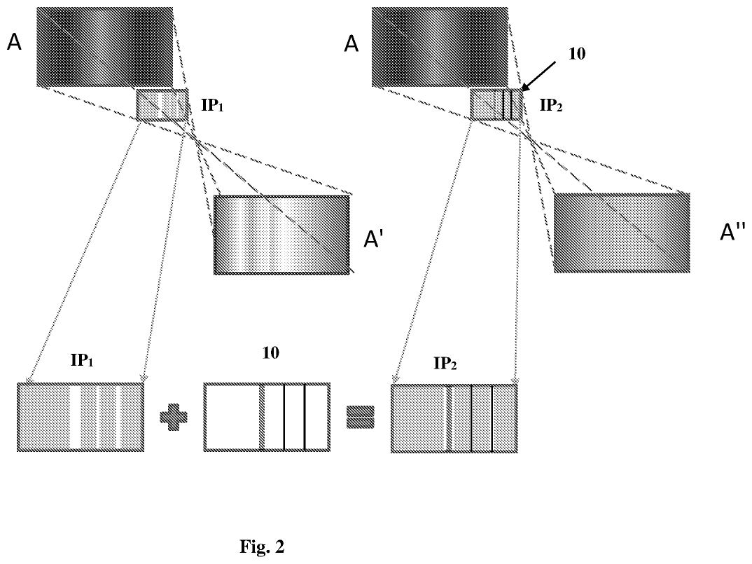

As described above, a uniform input scene a passing through any optical element undergoes non-uniformities. This is illustrated for example in images labelled A in FIG. 2. This phenomenon is due to the non-uniform transfer function of the optical unit. The light outputted from the optical unit has a non-uniform intensity profile IP₁ defining regions of different brightnesses. The correction mask 10 (i.e. masking element) is configured for affecting regions of relatively high light intensity within the intensity profile to thereby create a uniform intensity profile IP₂. For example, a processing unit may receive an image indicative of an input light such as images A and may extract data indicative of an intensity profile IP₁ defining regions (width and pitch) of different brightnesses. The data may be analyzed to determine the spatially varying transmission profile to be applied to the input light across the certain field of view to apply intensity modulation to the input light to affect regions of relatively high light intensity within the intensity profile. For example, the image may be segmented into a plurality of bands and the brightness of each band may be calculated and compared to a reference brightness corresponding to the background brightness. The spatial location of these bands as well as the width of such bands may be extracted from the image to determine a varying transmission profile corresponding to the non-uniform intensity profile. Alternatively, the varying transmission profile may be determined by using simulations results based on the transfer function of the optical unit. Additionally or alternatively to the simulations and/or to the identifying process, the masking optical element may be placed at the output of the optical unit and preliminary measurements of optical characteristics of the optical unit may be conducted. An image at the output of the optical system may be analyzed to identify an arrangement of the regions of relatively high light intensity in the field of view. If some regions have still an over brightness as compared to the brightness of the background, the varying transmission profile of the masking optical element may be readjusted (spatial location, width and optical density of the obstructing regions) accordingly to affect such regions of over brightness. The measured beam profile is then compared to the modeled beam profile. As illustrated in FIG. 2, the non-uniform intensity profile IP₁ may be corrected by applying a selected apodization profile to light transmitted along the optical pathway. The image A′ obtained without the correction shows fringes, or bands of lower/higher intensity, while the image A″ obtained after applying the correction mask has clearly a uniform brightness.

It should be noted that the intensity profile of an optical unit of the known characteristics can be properly modeled/simulated. Actually such optical characteristics defining the intensity profile across a given field of view of the optical unit include one or more of the following: an optical path defined by the optical unit, number and type of interactions the light undergoes with interfaces along the optical path (e.g. light directing surfaces 22 in the LOE exemplified above), as well as refractive indices of media along the optical path, and given intensity profile of light being input in the optical unit.

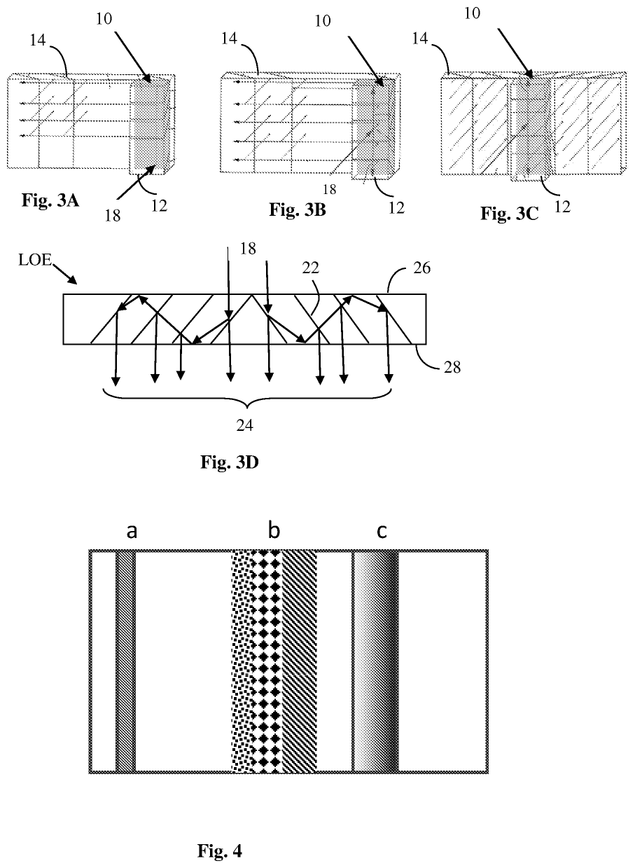

FIGS. 3A-3C show different specific non-limiting examples of LOE-based optical systems of different configurations and different positions of the correction masking element 10 suitable for use in the see-through near-eye display. As described above (FIG. 1B), illumination uniformity correction masking optical element 10 may be placed at the output of the LOE 12 whose illumination non-uniformity is to be corrected, and may be further followed by another optical unit 14.

In some embodiments, the masking optical element 10 may be placed between two LOE's 12 and 14 as shown in FIG. 3A. Here, light 18 indicative of the virtual image enters LOE 12, and while being guided by total internal reflection from major surfaces thereof is reflected by at least partially reflective surface (not seen here) onto the masking element 10, which is configured in accordance with the predetermined (measured and/or modeled) illumination non-uniformity profile of the element 12. The so illumination-corrected light enters LOE 14 to propagate in manner described above and being reflected out of the LOE 14 towards an observer.

In the specific not limiting examples of FIGS. 3B and 3C, one of the LOEs (FIG. 3B) or both of them (FIG. 3C) is configured also as a light expander. An example of such expander configuration of LOE is schematically illustrated in FIG. 3D. As shown virtual-image light 18 enters the LOE at a center region thereof (generally, intermediate region) and after interacting with oppositely symmetric surfaces 22 starts propagation, via total internal reflection, in two opposite directions along the LOE being partially transmitted and partially reflected in an output direction thus creating an expanded light output 24.

In the example of FIG. 3B, the optical unit 12 is configured as such an expander, and the masking optical element 10 is placed between the LOE 12 and LOE 14. In the example of FIG. 3C, the two optical elements 12 and 14 are configured as expander-LOEs for successively expanding light field indicative of the virtual image along two perpendicular axes, respectively The masking optical element 10 is placed between the expanders 12 and 14.

More specifically, in these specific and non-limiting examples, masking optical element 10 is placed at the optical interface between first and second optical units 12 and 14 for optically coupling the light outputted from optical unit 12 with a certain field of view and certain illumination non-uniformity profile across said field of view, to improve the illumination uniformity by applying a spatial transmission function to said light field and allow its input to the optical unit 14. In the examples of FIGS. 3A-3C, the two optical units are configured as two cascaded waveguides or LOEs, configured as described above.

The spatially varying transmission profile of the masking optical element has some variable parameters appropriately selected according to the transfer function of the optical unit(s) upstream of the masking optical element to provide improved illumination uniformity of the scene. For example, such parameters include at least one of width, pitch and optical density of the obstructing regions of the masking element. Obstruction regions may be opaque and/or partially transparent, based on thin-layer(s), absorber and/or pattern, including diffractive. In this connection, it should be noted that the masking element can be diffractive to aid the desired light distribution. The varying transmission profile may be defined to affect regions having a high amplitude as described above. Additionally or alternatively, the varying transmission profile may be diffractive to affect regions having a non-uniform phase.

It should be noted that although the embodiments described above are exemplified via a mono-ocular optical system, that is, the image is projected onto a single eye, the invention can be used in applications, such as head-up displays (HUD), wherein it is desired to project an image onto both eyes.

FIG. 4 schematically shows examples of various spatially varying transmission profiles. The pattern is characterized by a predetermined arrangement of the regions defined by predetermined dimensions of the regions, spaces between them, and optical density of said regions. Example a shows an opaque obstructing. Example b shows a binary pattern. Example c shows a varying transmittance. In this connection, it should be noted that the intensity profile defines a plurality of regions having Gaussian distribution. However, the entire Gaussian profile might not be entirely masked but a masking portion having an undersized function (e.g. squared) masking the majority of the region of relatively high light intensity (around the intensity peak) is sufficient to obtain an overall uniform intensity profile. The spatially varying transmission profile is configured for reducing the intensity of the regions of high brightness to an average brightness level. To this end, the masking optical element may comprise absorbing regions. The complete obstruction of such regions is not necessary. The spatially varying transmission profile may be determined by using an apodization function changing the input intensity profile.

1. An optical system for use in a near-eye display device for projecting a virtual image, the optical system comprising:
an optical unit defining a light guiding channel for guiding input light indicative of the virtual image through said channel and providing output light with a field of view, said output light having a predetermined non-uniform intensity profile across said field of view; and
a masking optical element optically coupled to an output of said optical unit for output light passage through the masking optical element, said masking optical element having a spatially varying transmission profile across said element configured in accordance with said predetermined non-uniform intensity profile, to affect regions of relatively high light intensity within said intensity profile to thereby apply intensity modulation to light passing through the masking optical element to provide virtual image with improved light intensity uniformity.

2. The optical system of claim 1, wherein said varying transmission profile of the masking optical element is configured to affect the light intensity in said regions to be below a certain threshold.

3. The optical system of claim 1, wherein said masking optical element has at least one of the following configurations: (i) said masking optical element comprises a pattern formed by an array of two or more spaced-apart regions of different transmissions, thereby providing said varying transmission profile; and (ii) said masking optical element comprises a pattern of successive regions of continuously varying transmission, thereby providing said varying transmission profile.

4. (canceled)

5. The optical system of claim 3, wherein said pattern is characterized by a predetermined arrangement of said regions defined by predetermined dimensions of the regions, spaces between them, and optical density of said regions.

6. The optical system of claim 3, wherein said pattern providing the varying transmission profile corresponds to a projection of said predetermined non-uniform intensity profile across said field of view onto said masking optical element.

7. The optical system according to claim 1, wherein said optical unit comprises a light guiding element configured to guide the input light propagation therethrough via total internal reflections from major surfaces of the light guiding element.

8. The optical system of claim 7, wherein said optical unit is configured as a beam expander.

9. The optical system of claim 7, wherein said light guiding element comprises a substrate having said major surfaces and one or more at least partially reflective surfaces embedded in said substrate for reflecting the light indicative of the virtual image out of said body towards the masking optical element.

10. The optical system according to claim 1, further comprising an additional optical unit optically coupled to said masking optical element for guiding the intensity modulated light emerging from the masking optical element to be output from the display device in one or more output directions.

11. The optical system of claim 10, wherein said additional optical unit is configured as a light-guide for guiding light propagation therethrough by total internal reflection from major surface of the light guide, and having one or more at least partially reflective surfaces for reflecting the virtual image light towards one or more output directions.

12. The optical system of claim 11, wherein said additional optical unit is configured as a beam expander.

13. The optical system according to claim 10, wherein said optical unit and said additional optical unit are configured as beam expanders to successively expand the light indicative of the virtual image along two perpendicular axes, respectively.

14. The optical system of claim 11, wherein at least said light guide of the additional optical unit is configured as a see-through light guide element for guiding the virtual image being projected and transmitting a real scene image, thereby augmenting the virtual image onto the real scene image.

15. An optical system for use in a near-eye display device for projecting a virtual image, the system comprising:
first and second light guiding elements, each configured for guiding input light indicative of the virtual image through a substrate of the light guiding element by total internal reflections from major surfaces of the substrate, the first and second light guiding elements being accommodated in a cascaded fashion such that the second guiding element is optically coupled to an output of the first guiding element; and
a masking optical element accommodated at an optical interface between the first and second light guiding elements for optically coupling the light outputted from the first guiding element with a certain field of view to an input of the second light guiding element, wherein said masking optical element has a spatially varying transmission profile across said element configured in accordance with a predetermined non-uniform intensity profile of the light output of the first light guiding element across said field of view, said spatially varying transmission profile affecting regions of relatively high light intensity within said non-uniform intensity profile, thereby applying intensity modulation to the light passing through the masking optical element to improve intensity uniformity of light being input to the second light guiding element.

16. An optical system for use in a near-eye display device for projecting a virtual image, the system comprising:
an optical unit having an optical pupil, and configured to define a light guiding channel for guiding light through said channel to be output from the optical unit in one or more output directions; and
a masking optical element accommodated upstream of the optical unit with respect to a general propagation direction of light through the optical system, said masking optical element projecting input light indicative of the virtual image onto said optical pupil of the optical unit, wherein said masking optical element has a spatially varying transmission profile across said element configured in accordance with a predetermined non-uniform intensity profile of the input light, to affect regions of relatively high light intensity within said non-uniform intensity profile, thereby applying intensity modulation to the light passing through the masking optical element to improve intensity uniformity of light being input to the optical pupil of the optical unit.

17. The optical system of claim 16, wherein said optical unit comprises a light guiding element configured to guide the light propagation therethrough via total internal reflections from major surfaces of the light guiding element.

18. The optical system of claim 17, wherein said light guiding element is configured as beam expander.

19. A method for improving intensity uniformity of light, indicative of a virtual image in a near-eye display device, the method comprising:
providing data indicative of a non-uniform intensity profile of input light indicative of the virtual image across a certain field of view; and
analyzing said data indicative of the non-uniform intensity profile of the input light, and determining a spatially varying transmission profile to be applied to the input light across said certain field of view to apply intensity modulation to the input light to affect regions of relatively high light intensity within said intensity profile and thereby improve intensity uniformity of said light.

20. The method of claim 19, wherein said spatially varying transmission profile comprises at least one of the following configurations: (a) said spatially varying transmission profile is configured to affect the light intensity in said regions to be below a certain threshold; (b) said spatially varying transmission profile comprises a pattern formed by an array of two or more spaced-apart regions of different transmissions; and (c) said spatially varying transmission profile comprises a pattern of successive regions of continuously varying transmission.

21-22. (canceled)

23. The method of claim 19, wherein said spatially varying transmission profile comprises at least one of the following configurations: comprises a pattern formed by an array of two or more spaced-apart regions of different transmissions; and comprises a pattern of successive regions of continuously varying transmission; and wherein said determining of the spatially varying transmission profile comprises determining at least one of dimensions, pitch and optical density of said regions of the pattern.

24. The method of claim 19, wherein said providing of the data indicative of the non-uniform intensity profile comprises conducting preliminary measurements of optical characteristics of an optical unit producing said input light indicative of the virtual image, and identifying an arrangement of the regions of relatively high light intensity in the field of view.

25. The method of claim 19, comprising selectively applying a selected apodization profile to said input light.
